(19) United States
(12) Patent Application Publication
(10) Pub. No.: US 2025/0180975 A1
(43) Pub. Date: Jun. 5, 2025

(54) SWITCHING APPARATUS, CASING OF CAMERA EQUIPMENT AND CASING ASSEMBLY OF CAMERA EQUIPMENT

(71) Applicant: SHENZHEN NEEWER TECHNOLOGY CO. LTD, Shenzhen (CN)

(72) Inventors: Faan YANG, Shenzhen (CN); Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 18/733,468

(22) Filed: Jun. 4, 2024

(30) Foreign Application Priority Data
Dec. 1, 2023 (CN) 202323305303.8
Apr. 30, 2024 (CN) 202420943417.0

(51) Int. Cl. G03B 17/56

(52) U.S. Cl. CPC G03B 17/566

(57) ABSTRACT

A switching apparatus includes a switching main body. One side of the switching main body is provided with a hollowed installation ring, an inside of the installation ring is detachably connected to an installation boss of the casing of the camera equipment, another side of the switching main body is provided with a shielding structure, the shielding structure is an annular hollowed structure, and an inside of the annular hollowed structure is detachably connected to the filter.

### CROSS-REFERENCE TO RELATED APPLICATIONS

The present application claims priority to Chinese Patent Application No. 202323305303.8, filed on Dec. 1, 2023 and Chinese Patent Application No. 202420943417.0, filed on Apr. 30, 2024, the entire contents of which are incorporated herein by reference.

### TECHNICAL FIELD

The present application relates to the technical field of camera equipment, and in particular to a switching apparatus, a casing of a camera equipment and a casing assembly of the camera equipment.

### BACKGROUND

With the continuous development of photography technology, people's requirements for photography equipment are also constantly increasing. In order to take more beautiful photos, users usually need to replace different filters to achieve the desired shooting effect. As the camera functions of smartphones become more and more powerful, people more tend to use smartphones rather than professional cameras to take photos or videos in some daily application scenarios. However, although the pixels of smartphone cameras are getting higher and higher, they lack the support of various lenses or filters in terms of optical imaging, and there is still a big gap between the final shooting effect and professional cameras.

Most mobile phones are provided with phone casing. The phone casing is used to cover the mobile phone and play a certain role in protecting the mobile phone. In order to facilitate the installation of filters on the mobile phone to meet the user's shooting needs, the phone casing in the related art is usually provided with the switching apparatus. The phone casing is provided with an installation boss at the position corresponding to the phone camera. The installation boss is provided with a camera through hole corresponding to the phone camera. The switching apparatus is connected to the outside of the installation boss of the phone casing. The filter is installed outside the switching apparatus, which will make the overall structure of the phone casing larger, and makes it inconvenient for users to use. Moreover, the filter is installed on the switching apparatus through magnetic attraction. In this way, since the filter is on the outermost side, it is easily touched by external forces and falls, which affects the user's experience.

### SUMMARY

In view of this, the present application provides a switching apparatus, a casing of a camera equipment and a casing assembly of the camera equipment to solve the problem in the related art that the overall structure of the phone casing is large in size and the filter is easy to fall.

In a first aspect, the present application provides a switching apparatus, one side of the switching apparatus is detachably connected with a filter, another side of the switching apparatus is detachably connected with a casing of a camera equipment, and the switching apparatus includes a switching main body. One side of the switching main body is provided with a hollowed installation ring, an inside of the installation ring is detachably connected to an installation boss of the casing of the camera equipment, another side of the switching main body is provided with a shielding structure, the shielding structure is an annular hollowed structure, and an inside of the annular hollowed structure is detachably connected to the filter.

Beneficial effects: the installation ring is provided on one side of the switching main body, the installation boss of the casing of the camera equipment can be detachably connected in the installation ring during use to achieve the purpose of installation positioning. The other side of the switching main body is provided with a shielding structure, and a filter is detachably connected in the installation space of the shielding structure, so that the overall structure size of the switching apparatus and the casing of the camera equipment is reduced, which is convenient for users to use and store. The shielding structure is provided on the other side of the switching main body, so that the filter is fixedly connected to the installation space of the shielding structure instead of being exposed to the outside, thus external forces are not easy to directly touch the filter, which can protect the filter to a certain extent, prevent it from falling, and improve the user's experience.

In an embodiment, a first positioning structure is provided on an inner ring wall of the installation ring, a second positioning structure is provided on the installation boss of the casing of the camera equipment, and the first positioning structure is matched and connected with the second positioning structure.

In an embodiment, the first positioning structure is a telescopic structure, and the second positioning structure is a positioning hole. The telescopic structure has a first state and a second state. The telescopic structure is clamped with the positioning hole in the first state, and the telescopic structure is separated from the positioning hole in the second state.

Beneficial effects: the first positioning structure is configured as a telescopic structure, which is easy to snap and fix with the positioning hole, and to retract and separate from the positioning hole under the action of external force, making it more convenient to disassembly and assembly the switching apparatus and the casing of the camera equipment.

In an embodiment, the telescopic structure includes a first elastic member and a protruding portion. One end of the first elastic member is connected to the inner ring wall, the protruding portion is connected to another end of the first elastic member, and the protruding portion is configured to extend into the positioning hole in the first state.

In an embodiment, a second elastic member is provided on the inner ring wall of the installation ring and is configured to be between the installation boss and the installation ring in response to that the installation boss is assembled with the installation ring.

Beneficial effects: the second elastic member is provided on the inner ring wall of the installation ring, which can provide a certain assembly deviation compensation when the installation boss is assembled with the installation ring, thereby preventing loosening, and improving the assembly reliability of the installation boss and the installation ring.

In an embodiment, the second elastic member is a silicone pad or a rubber pad.

In an embodiment, a plurality of first positioning structures and a plurality of second elastic members are respectively provided along a circumferential direction of the installation ring.

In an embodiment, the first positioning structure is an inner thread and the second positioning structure is an outer thread.

In an embodiment, a third elastic member is provided at an end portion of the installation ring close to the casing of the camera equipment, and the third elastic member is abutted against a casing body of the casing of the camera equipment.

Beneficial effects: the third elastic member is provided at the end portion of the installation ring close to the casing of the camera equipment. When the switching apparatus and the casing of the camera equipment are assembled together, the third elastic member is abutted against the casing body of the casing of the camera equipment to prevent scratches to the casing of the camera equipment during assembly.

In an embodiment, the shielding structure is threaded with the filter.

In an embodiment, the shielding structure is magnetically connected to the filter.

In an embodiment, the shielding structure is clamped with the filter.

Beneficial effects: the filter is detachably connected in the shielding structure, and the filter can cover the outer opening of the hollowed structure of the annular shielding structure, so that the shielding structure, the ring wall of the installation ring and the filter can cooperate together to form a sealed area with the camera area of the camera equipment, and light can only enter the sealed area through the filter and enter the camera through the light through hole, which achieves the purpose of filtering certain light waves, thereby obtaining photos with a certain photographic effect and improving the shooting effect.

In a second aspect, the present application also provides a casing of the camera equipment for cooperating with the switching apparatus. The casing of the camera equipment includes: a casing body provided with an installation boss cooperated with an installation ring of the switching apparatus, the installation boss is provided with a light through hole corresponding to a camera of the camera equipment; and a second positioning structure locked with the switching apparatus is provided on the installation boss.

In a third aspect, the present application also provides a casing assembly of the camera equipment, including: the casing of the camera equipment, the switching apparatus, and the filter. One side of the switching apparatus is detachably installed on the casing of the camera equipment, and the filter is detachably installed on another side of the switching apparatus.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a switching apparatus from a first perspective according to an embodiment of the present application.

FIG. 2 is a schematic structural view of the switching apparatus from a second perspective according to an embodiment of the present application.

FIG. 3 is a schematic structural view of the switching apparatus from the second perspective according to an embodiment of the present application.

FIG. 4 is a schematic structural view of a phone casing according to an embodiment of the present application.

FIG. 5 is a schematic structural view of the phone casing according to an embodiment of the present application.

FIG. 6 is a schematic structural view of a casing body of the phone casing according to an embodiment of the present application.

FIG. 7 is a schematic structural view of the casing body of the phone casing according to an embodiment of the present application.

The realization of the objective, functional characteristics, and advantages of the present application are further described with reference to the accompanying drawings.

### DETAILED DESCRIPTION OF THE EMBODIMENTS

In order to make the purpose, the technical solution and the advantage of the present application clearer, the technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

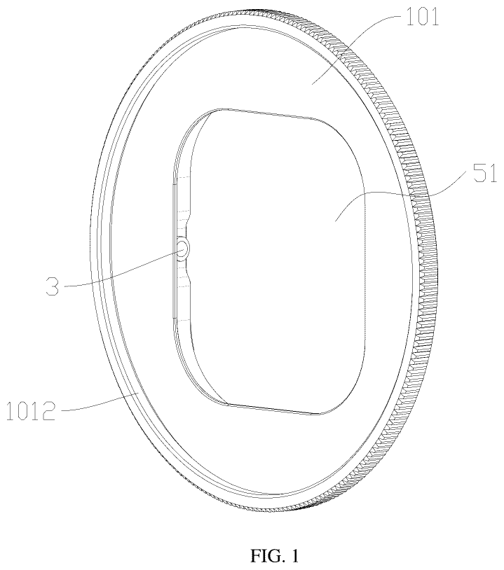

Embodiments of the present application are described below with reference to FIG. 1 to FIG. 7.

The present application provides a switching apparatus. One side of the switching apparatus is configured to detachably connect to a filter, and the other side of the switching apparatus is configured to detachably connect to a casing of the camera equipment. The switching apparatus 1 includes a switching main body 101. One side of the switching main body 101 is provided with a hollowed installation ring 1011, and the inside of the installation ring 1011 is configured to detachably connect to an installation boss 202 of the casing of the camera equipment. The other side of the switching main body 101 is provided with a shielding structure 1012. The shielding structure 1012 is an annular hollowed structure, the inside of the hollowed structure is configured to detachably connect to the filter, and the hollowed installation ring 1011 is communicated with the shielding structure 1012 through an optical through window 51.

The installation ring 1011 is provided on one side of the switching main body 101, the installation boss 202 of the camera equipment can be detachably connected in the installation ring 1011 during use to achieve the purpose of installation positioning. The other side of the switching main body 101 is provided with the shielding structure 1012, and the filter is detachably connected in the installation space of the shielding structure 1012, which reduces the size of the overall structure of the switching apparatus 1 and the casing of the camera equipment assembled together, and makes it convenient for users to use and store. The other side of the switching main body 101 is provided with the shielding structure 1012, and the filter can be fixedly connected in the installation space of the shielding structure 1012 without being exposed to the outside. In this way, the filter will not be easily touched directly by external force, the shielding structure 1012 can play a certain protective role on the filter and prevent the filter from falling, which improves the user's experience.

In this embodiment, the casing of the camera equipment is a phone casing. In an embodiment, the casing of the camera equipment may be a casing of a tablet computer.

In this embodiment, the inner ring wall of the installation ring 1011 is provided with a first positioning structure, and the installation boss 202 of the phone casing 2 is provided with a second positioning structure. The first positioning structure is cooperated with the second positioning structure.

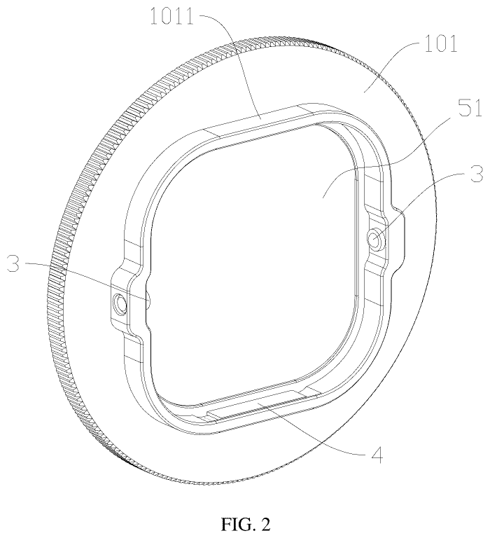

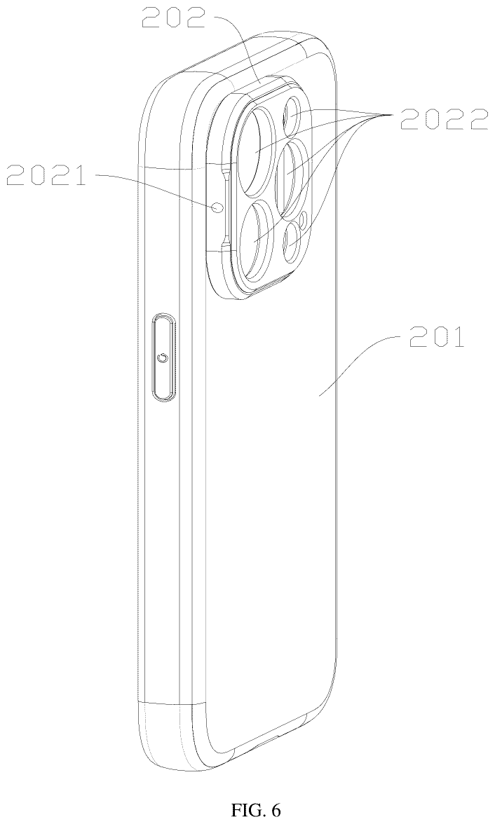

There are many specific forms of the first positioning structure and the second positioning structure. In this embodiment, as shown in FIG. 2 and FIG. 6, the first positioning structure is a telescopic structure 3, the second positioning structure is a positioning hole 2021. The telescopic structure 3 has a first state and a second state. The telescopic structure 3 is clamped with the positioning hole 2021 in the first state, and the telescopic structure 3 is separated from the positioning hole 2021 in the second state. The first positioning structure is the telescopic structure 3, which makes it convenient to extend and clamp with the positioning hole 2021 and to retract and separate from the positioning hole 2021 under the action of external force, thereby making it more convenient to disassembly and assembly the switching apparatus 1 and the phone casing 2.

As shown in FIG. 6, the positioning hole 2021 of the phone casing 2 is a recess hole. In an embodiment, the positioning hole 2021 may be a through hole. However, when the telescopic structure 3 extends into the through hole, it must have a certain distance from the camera of the imaging device and should not interfere with the camera.

As shown in FIG. 2, the telescopic structure 3 includes: a first elastic member and a protruding portion. One end of the first elastic member is connected to the inner ring wall. The protruding portion is connected to the other end of the first elastic member. In the first state, the protruding portion is configured to extend into the positioning hole 2021. Specifically, the first elastic member is a spring, the protruding portion is a spherical marble, and a recess hole is provided on the inner ring wall. One end of the spring is installed on the bottom wall of the recess hole, and the other end of the spring is abutted against the marble. When the installation boss 202 of the phone casing 2 is inserted into the installation ring 1011, the marble first overcomes the elastic force of the spring and retracts into the inner ring wall of the installation ring 1011. When the marble moves to the position directly facing the positioning hole 2021 of the installation boss 202, the marble is pushed into the positioning hole 2021 by the spring, and the switching apparatus 1 is matched and fixed with the phone casing 2. When the switching apparatus 1 needs to be disassembled, the installation boss 202 only needs to be pulled out from the outside with force. In an embodiment, the protruding portion may be a round ball. The round ball is located in the recess groove, and the diameter of the round ball is larger than that of the opening of the recess groove. The round ball is protrudingly provided outward from the recess groove. A first elastic member is provided between the round ball and the bottom of the recess groove. In an embodiment, the telescopic structure 3 may also include a nested sleeving assembly. The sleeving assembly includes a cylinder, and the first elastic member and the round ball are accommodated in the cylinder. The diameter of the round ball is greater than the opening diameter of the cylinder. The first elastic member is provided between the bottom of the cylinder and the round ball, and is configured to pop the round ball out of the opening.

In this embodiment, a second elastic member 4 is provided on the inner ring wall of the installation ring 1011, which is provided between the installation boss 202 and the installation ring 1011 when the installation boss 202 is assembled with the installation ring 1011. Specifically, the second elastic member 4 is a silicone pad. The second elastic member 4 is provided on the inner ring wall of the installation ring 1011, which can provide a certain assembly deviation compensation when the installation boss 202 is assembled with the installation ring 1011, thereby preventing loosening, and improving the assembly reliability of the installation boss 202 and the installation ring 1011. In an embodiment, the second elastic member 4 can also be a rubber pad. In an embodiment, it is also possible that the second elastic member 4 is not provided on the inner ring wall of the installation ring 1011.

As shown in FIG. 2, the installation ring 1011 has a square structure. Along the circumferential direction, two first positioning structures and two silicone pads are provided on the inner ring wall of the installation ring 1011. The two first positioning structures are opposite to each other, and the two silica gel pads are opposite to each other, so as to avoid interference caused by the first positioning structure and the silica gel pads. At the same time, the volume of the installation ring 1011 can be reduced. In an embodiment, one or more first positioning structure and one or more silicone pad are provided respectively. In an embodiment, a plurality of first positioning structures are arranged adjacently and a plurality of silicone pads are arranged adjacently. In an embodiment, the installation ring 1011 may be wider, and the first positioning structure may be set adjacent to the silicone pad along the axial direction of the installation ring 1011.

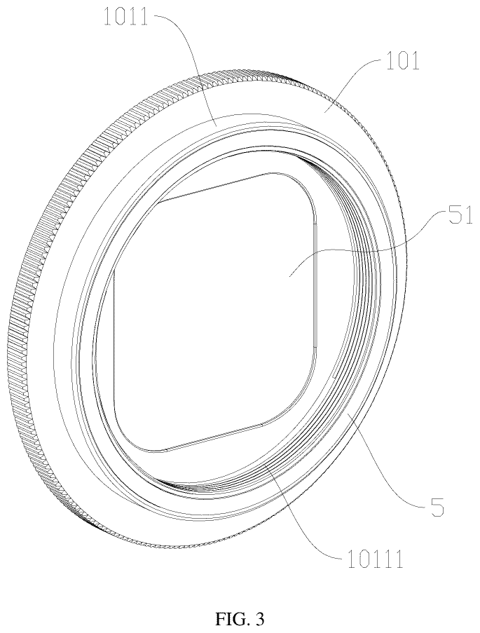

In other embodiments, as shown in FIG. 3, the installation ring 1011 has a circular structure, the first positioning structure is an inner thread 10111, the second positioning structure is an outer thread 2023, and the switching apparatus 1 is threaded to the phone casing 2.

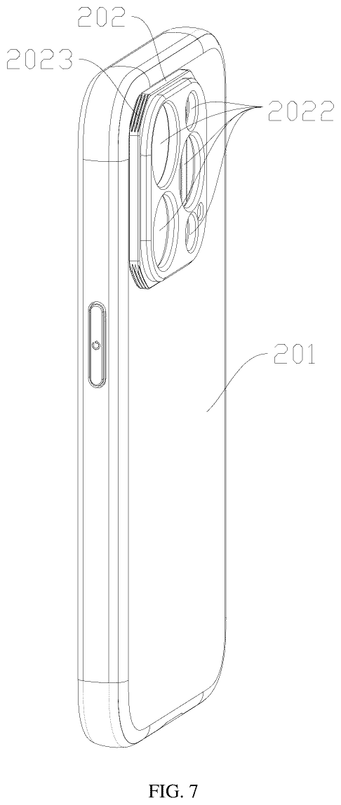

Since the installation boss 202 of the phone casing 2 is generally polygonal, when the installation boss 202 is threadedly connected to the installation ring 1011, part of the installation boss 202 is provided with the outer thread 2023. As shown in FIG. 7, the outer thread 2023 needs to be set on the circumscribed circle that matches the inner thread 10111 of installation ring 1011. In an embodiment, the installation boss 202 may be circular, and all outer walls of the installation boss 202 are provided with the outer threads 2023.

In this embodiment, as shown in FIG. 3, a third elastic member is provided at the end portion of the installation ring 1011 close to the phone casing 2, and the third elastic member is adapted to be abutted against the casing body 201 of the phone casing 2. Specifically, the third elastic member is an elastic ring 5, such as a rubber ring, a silicone ring, and a plastic ring, etc. Since the third elastic member is provided at the end portion of the installation ring 1011 close to the phone casing 2, when the switching apparatus 1 and the phone casing 2 are assembled together, the third elastic member is abutted against the casing body 201 of the phone casing 2, which can prevent scratches to the phone casing 2 during the assembly process.

As shown in FIG. 1, the shielding structure 1012 is an annular shielding sidewall configured to be threaded with the filter. In an embodiment, the shielding structure 1012 may be adapted to be magnetically connected to the filter, or the shielding structure 1012 may be adapted to be clamped with the filter, or the shielding structure 1012 may be connected to the filter through at least two ways of the threaded connection, the magnetic connection and the clamping connection.

Since the filter is detachably connected in the shielding structure 1012, the filter can cover the outer opening of the hollowed structure of the annular shielding structure 1012, so that the shielding structure 1012, the switching main body 101 and the ring wall of the installation ring 1011 can cooperate with the filter to form a sealed area with the camera area of the camera equipment. The light can only enter the sealed area through the filter and enter the camera through the light through hole 2022, which achieves the purpose of filtering certain light waves, thereby obtaining photos with certain photographic effects and improving the shooting effect.

In this embodiment, the overall structure of the switching apparatus 1 is annular, and the switching apparatus 1 is a switching ring.

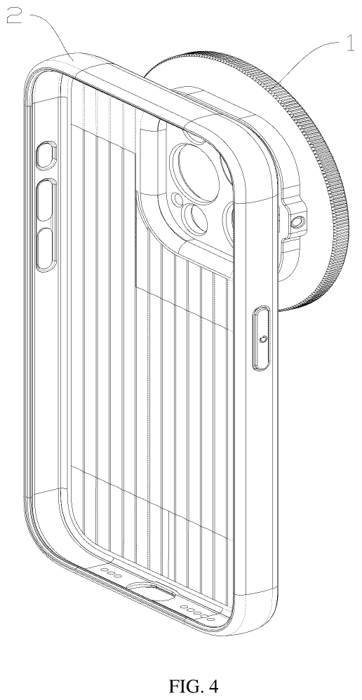

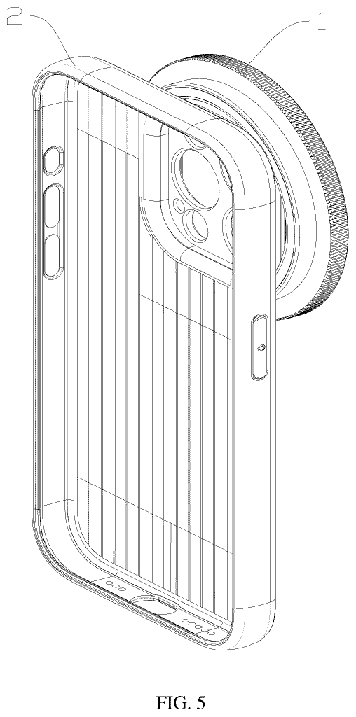

As shown in FIG. 4 and FIG. 5, according to an embodiment of the present application, on the other hand, a casing of the camera equipment is also provided for cooperating with the switching apparatus. The casing of the camera equipment includes a casing body 201 provided with an installation boss 202 cooperated with the installation ring 1011 of the switching apparatus 1. The installation boss 202 is provided with a light through hole 2022 configured for being installed correspondingly to the camera of the camera equipment. A second positioning structure locked with the switching apparatus 1 is provided on the installation boss 202.

In this embodiment, the casing of the camera equipment is the phone casing.

The installation boss 202 of the phone casing 2 is located on the back of the casing body 201 of the phone casing 2, and is in the area facing the camera of the mobile phone arranged in the phone casing 2. The installation boss 202 is provided with a light through hole 2022 facing the camera. The installation boss 202 of phone casing 2 can be matched and nested with the installation ring 1011 of the switching apparatus 1. The switching apparatus 1 realizes mutual installation by nesting the installation boss 202 of the phone casing 2 in the installation ring 1011. The hollowed portion of the installation ring 1011 of the switching apparatus 1 is communicated with the light through hole 2022 of the installation boss 202 of the phone casing 2, and forms a closed space with the installed filter. The shielding structure 1012 on the other side of the switching apparatus 1 can block the entry of the external light, ensuring that the light can only enter the camera of the mobile phone through the filter and the light through hole 2022, so as to prevent affecting the light filtering effect.

In an embodiment, the switching main body 101 may be provided with an optical through window 51, and the edge of the optical through window 51 is acted as the installation ring 1011. The telescopic structure 3 is mounted on the sidewall of the optical through window 51.

In an embodiment, the telescopic structure 3 is provided on the installation boss 202, and the positioning hole 2021 is provided on the inner ring wall of the installation ring 1011.

According to an embodiment of the present application, a casing assembly of the camera equipment is also provided, including: the casing of the camera equipment, the switching apparatus and the filter. One side of the switching apparatus is detachably installed on the casing of the camera equipment, and the filter is detachably installed on the other side of the switching apparatus.

Although embodiments of the present application are described with reference to the drawings, those skilled in the art may make various modifications and variations without deviating from the spirit and scope of the present application, and such modifications and variations fall in the scope of the present application.

What is claimed is:

1. A switching apparatus, wherein one side of the switching apparatus is configured to detachably connect with a filter, another side of the switching apparatus is configured to detachably connect with a casing of a camera equipment, and the switching apparatus comprises:
a switching main body, wherein one side of the switching main body is provided with a hollowed installation ring, an inside of the installation ring is configured to detachably connect to an installation boss of the casing of the camera equipment, another side of the switching main body is provided with a shielding structure, the shielding structure is an annular hollowed structure, and an inside of the annular hollowed structure is configured to detachably connect to the filter.

2. The switching apparatus according to claim 1, wherein a first positioning structure is provided on an inner ring wall of the installation ring, a second positioning structure is provided on the installation boss of the casing of the camera equipment, and the first positioning structure is matched and connected with the second positioning structure.

3. The switching apparatus according to claim 2, wherein:
the first positioning structure is a telescopic structure, and the second positioning structure is a positioning hole,
the telescopic structure has a first state and a second state, and
the telescopic structure is clamped with the positioning hole in the first state, and the telescopic structure is separated from the positioning hole in the second state.

4. The switching apparatus according to claim 3, wherein the telescopic structure comprises:
a first elastic member, wherein one end of the first elastic member is connected to the inner ring wall; and
a protruding portion connected to another end of the first elastic member, wherein the protruding portion is configured to extend into the positioning hole in the first state.

5. The switching apparatus according to claim 2, wherein a second elastic member is provided on the inner ring wall of the installation ring and is configured to be between the installation boss and the installation ring in response to that the installation boss is assembled with the installation ring.

6. The switching apparatus according to claim 5, wherein the second elastic member is a silicone pad or a rubber pad.

7. The switching apparatus according to claim 5, wherein a plurality of first positioning structures and a plurality of second elastic members are respectively provided along a circumferential direction of the installation ring.

8. The switching apparatus according to claim 2, wherein the first positioning structure is an inner thread and the second positioning structure is an outer thread.

9. The switching apparatus according to claim 2, wherein a third elastic member is provided at an end portion of the installation ring close to the casing of the camera equipment, and the third elastic member is abutted against a casing body of the casing of the camera equipment.

10. The switching apparatus according to claim 1, wherein the shielding structure is configured to be threaded with the filter.

11. The switching apparatus according to claim 1, wherein the shielding structure is magnetically connected to the filter.

12. The switching apparatus according to claim 1, wherein the shielding structure is clamped with the filter.

13. A casing of a camera equipment, comprising:
a casing body provided with an installation boss cooperated with an installation ring of the switching apparatus, wherein the installation boss is provided with a light through hole corresponding to a camera of the camera equipment;
wherein a second positioning structure locked with the switching apparatus is provided on the installation boss.

14. A casing assembly of a camera equipment, comprising:
a casing of a camera equipment configured to be cooperated with a switching apparatus; and
a filter;
wherein one side of the switching apparatus is detachably installed on the casing of the camera equipment, and the filter is detachably installed on another side of the switching apparatus;
the casing of the camera equipment comprises: a casing body provided with an installation boss cooperated with an installation ring of the switching apparatus, wherein the installation boss is provided with a light through hole corresponding to a camera of the camera equipment; and
a second positioning structure locked with the switching apparatus is provided on the installation boss.
